(19) United States
(12) Patent Application Publication
(10) Pub. No.: US 2007/0070222 A1
(43) Pub. Date: Mar. 29, 2007

(54) Method of eliminating horizontal pattern noise

(75) Inventor: Chin Hsun Wu, Taipei (TW)

Correspondence Address: BACON & THOMAS, PLLC, 625 SLATERS LANE, FOURTH FLOOR, ALEXANDRIA, VA, 22314, US

(73) Assignee: PREMIER IMAGE TECHNOLOGY CORPORATION, Taipei (TW)

(21) Appl. No.: 11/517,356

(22) Filed: Sep. 8, 2006

(30) Foreign Application Priority Data
Sep. 26, 2005 (TW) 094133393

(51) Int. Cl. H04N 5/217

(52) U.S. Cl. 348/241

(57) ABSTRACT

The present invention provides a method for eliminating horizontal pattern noise of an image signal captured by a digital camera, wherein the method comprises the steps of: obtaining the image signal; performing an optical black reset operation to the image signal after the short exposure time has substantially completed; waiting for a predetermined period after the optical black reset operation; and reading the image signal.

### BACKGROUND OF THE INVENTION

1. Field of the Invention

The present invention relates to a method of eliminating horizontal pattern noise, and more particularly, to a method for eliminating horizontal pattern noise of an image signal captured by a digital camera.

2. Description of the Related Art

Generally, when a user uses a digital camera to capture images, if the exposure time is very short (such as one one-thousandth of a second), the captured image will exhibit horizontal pattern noise problems. Horizontal pattern noise is caused by the way the prior art digital camera reads the image immediately after the exposure time. When the exposure time is very short, the digital camera needs to perform image reading quickly, even before the optical black signal has stabilized, and so the image is generated with horizontal pattern noise.

Please refer to both FIG. 1A and FIG. 1B. FIG. 1A is a schematic drawing of exposure and read cycles for an image according to the prior art technology. FIG. 1B shows another schematic drawing of image exposure and read cycles according to the prior art technology. As shown in FIG. 1A, if the exposure time is long enough (for example, longer than a thousandth of a second), when the digital camera performs image reading, the optical black signal has already stabilized. Therefore, no horizontal pattern noise problems are exhibited in subsequent image combination and digital signal processing processes.

On the other hand, as shown in FIG. 1B, if the exposure time is not long enough (shorter than a thousandth of a second), when the digital camera performs image reading, the optical black signal has not stabilized; therefore, horizontal pattern noise problems are introduced into subsequent image combination and digital signal processing processes. As shown in FIG. 1B, when the digital camera performs image reading on a first field, the optical black signal has not stabilized, and so a subsequently generated image will have lighter colors in areas corresponding to the first field, which is the source of the horizontal pattern noise.

Therefore, it is desirable to provide to a method of eliminating horizontal pattern noise to mitigate and/or obviate the aforementioned problems.

### SUMMARY OF THE INVENTION

The present invention is to provide a method for eliminating horizontal pattern noise of an image signal captured by a digital camera

The method of the present invention comprises: obtaining the image signal; performing an optical black reset operation to the image signal after the short exposure time has substantially completed; and reading the image signal.

In an embodiment of the present invention, the method further comprises a step of waiting for a predetermined period after the optical black reset operation

In the embodiment of the present invention, the optical black reset operation is accomplished by controlling a timing generator in the digital camera, and the step of waiting for a predetermined period is accomplished by setting a dummy frame.

Furthermore, the dummy frame has a duration of about 33 micro-seconds.

Other objects, advantages, and novel features of the invention will become more apparent from the following detailed description when taken in conjunction with the accompanying drawings.

### BRIEF DESCRIPTION OF THE DRAWINGS

FIG. 1A illustrates image exposure and read processes according to the prior art technology.

FIG. 1B shows another schematic drawing of image exposure and read processes according to the prior art technology.

FIG. 2 is a flow chart of the method of the present invention.

FIG. 3 is an illustration of image exposure and read processes according to the method of the present invention.

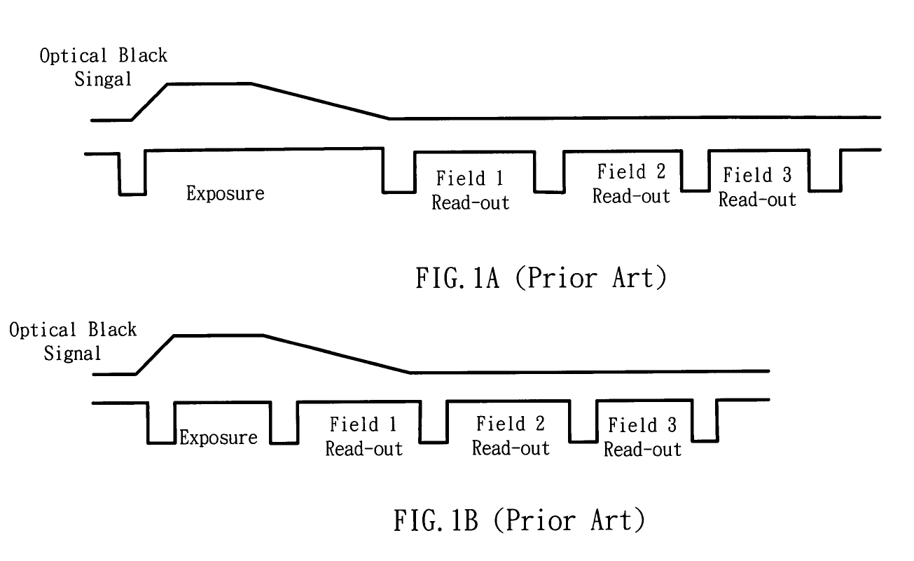

### DETAILED DESCRIPTION OF THE PREFERRED EMBODIMENT

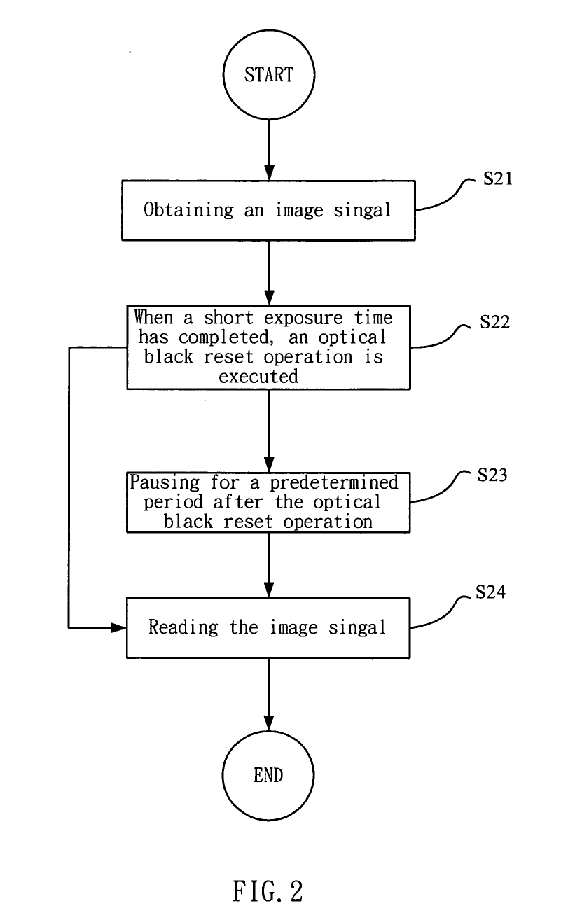

Please refer to FIG. 2. FIG. 2 shows a flow chart of the method of the present invention. As shown in FIG. 2, step S21 is performed to obtain an image signal. In step S21, a CCD lens of the digital camera can be utilized to capture the image signal. Since such image capturing technology in CCD lenses is a very well known technology, no further discussion of this technology is required.

To eliminate horizontal pattern noise in the image signal captured by the digital camera, step S22 is performed. When a short exposure time (for example, a thousandth of a second), as set by a user or automatically by the camera system, has completed, an optical black reset operation is executed on the image signal. In step S22, a timing generator in the digital camera is used to execute the optical black reset operation. Since such optical black reset operations executed by timing generators are a very well known technology, no further description is required.

After step S22, when the optical black signal of the digital camera has become more stable, step S24 may be executed to read the image signal of each field for further digital signal processing steps. As a result, the output image after the digital signal processing procedures will not have horizontal pattern noise problems.

Although after steps S21, S22 and S24 have been executed the image should not exhibit any horizontal pattern noise, in order to ensure that the image signal of each field is read after the optical black signal has stabilized, the present invention may execute step S23 after step S22, which is pauses for a predetermined period after the optical black reset operation. Then, step S24 is executed to read the image signal of each field for further digital signal processing processes.

Step S23 may be accomplished by controlling the timing generator in the digital camera to set up a dummy frame; the dummy frame may be 33 micro-seconds long. Since the setting up of dummy frames with timing generators is a very well known technology, no further description is required.

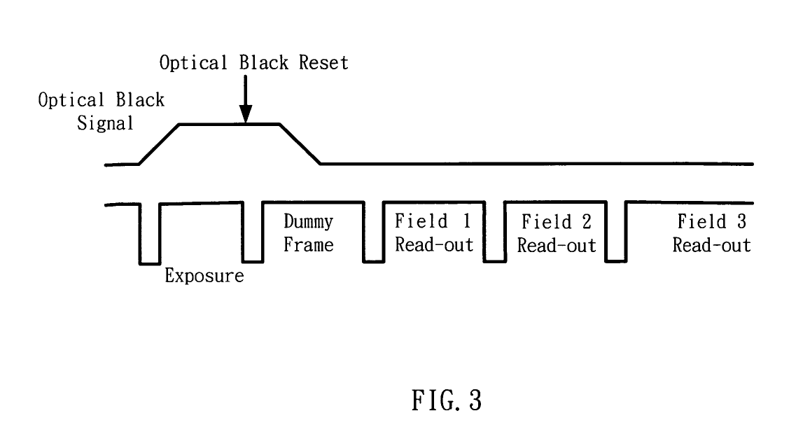

As shown in FIG. 3, the present invention stabilizes the optical black signal before the digital camera reads the image in the first field, and so the optical black signal will not affect the output image, thereby eliminating horizontal pattern noise in the image signal captured by the digital camera.

Although the present invention has been explained in relation to its preferred embodiment, it is to be understood that many other possible modifications and variations can be made without departing from the spirit and scope of the invention as hereinafter claimed.

What is claimed is:

1. A method for eliminating horizontal pattern noise of an image signal captured by a digital camera, the method comprising:
obtaining the image signal;
performing an optical black reset operation to the image signal after the short exposure time has substantially completed; and
reading the image signal.

2. The method as claimed in claim 1 further comprising:
waiting for a predetermined period after the optical black reset operation.

3. The method as claimed in claim 1, wherein the optical black reset operation is accomplished by controlling a timing generator in the digital camera.

4. The method as claimed in claim 3, wherein the step of waiting for a predetermined period is accomplished by setting a dummy frame.

5. The method as claimed in claim 4, wherein the step of setting the dummy frame is accomplished by controlling the timing generator.

6. The method as claimed in claim 4, wherein the dummy frame has a duration of about 33 micro-seconds.

7. The method as claimed in claim 2, wherein the optical black reset operation is accomplished by controlling a timing generator in the digital camera.

8. The method as claimed in claim 7, wherein the step of waiting for a predetermined period is accomplished by setting a dummy frame.

9. The method as claimed in claim 8, wherein the step of setting the dummy frame is accomplished by controlling the timing generator.

10. The method as claimed in claim 8, wherein the dummy frame has a duration of about 33 micro-seconds.
